(19) United States
(12) Patent Application Publication
(10) Pub. No.: US 2011/0122899 A1
(43) Pub. Date: May 26, 2011

(54) SEMICONDUCTOR LASER

(75) Inventors: Michael Kühnelt, Regensburg (DE); Peter Brick, Regensburg (DE); Stephan Lutgen, Regensburg (DE)

(73) Assignee: OSRAM OPTO SEMICONDUCTORS GMBH, Regensburg (DE)

(21) Appl. No.: 12/991,590

(22) PCT Filed: Jun. 17, 2009
(86) PCT No.: PCT/DE09/00862

§ 371 Date: Dec. 1, 2010

(30) Foreign Application Priority Data
Aug. 4, 2008 (DE) 10 2008 036 254.9

(51) Int. Cl. H01S 3/109

(52) U.S. Cl. 372/22

(57) ABSTRACT

A semiconductor laser includes a semiconductor laser element that emits electromagnetic radiation with at least one fundamental wavelength when in operation, an end mirror, a deflecting mirror reflective as a function of polarization located between the semiconductor laser element and the end mirror, and at least one optically nonlinear crystal configured for type II frequency conversion of the fundamental wavelength and which satisfies a λ/2 condition for the fundamental wavelength.

### RELATED APPLICATIONS

This is a §371 of International Application No. PCT/DE2009/000862, with an international filing date of Jun. 17, 2009, which is based on German Patent Application No. 10 2008 036 254.9, filed Aug. 4, 2008, the subject matter of which is incorporated by reference.

### TECHNICAL FIELD

This disclosure is related to semiconductor lasers.

### BACKGROUND

Lasers based on semiconductors offer major advantages over for instance gas or semiconductor lasers with an optically pumped YAG or YLF crystal as amplifier medium with regard to efficiency, maintenance effort and size of the component. The accessible wavelength range based on the band gap of the semiconductor material of semiconductor laser elements is, however, often in the near infrared spectral range. If the visible spectral range is to be obtained, it is therefore necessary for lasers emitting in the near infrared range to convert the frequency originally emitted by the semiconductor laser element, for example to double it. Frequency mixing or frequency conversion is normally an optically nonlinear effect, which is dependent on light intensity. To achieve high efficiency, frequency mixing therefore preferably takes place within a laser resonator due to the higher light intensity.

It could therefore be helpful to provide a semiconductor laser which exhibits high efficiency in the case of frequency conversion.

### SUMMARY

We provide a semiconductor laser including a semiconductor laser element that emits electromagnetic radiation with at least one fundamental wavelength when in operation, an end mirror, a deflecting mirror reflective as a function of polarization located between the semiconductor laser element and the end mirror, and at least one optically nonlinear crystal configured for type II frequency conversion of the fundamental wavelength and which satisfies a λ/2 condition for the fundamental wavelength.

### BRIEF DESCRIPTION OF THE DRAWINGS

FIG. 1 is a schematic plan view of an example of a semiconductor laser.

FIG. 2 is a schematic plan view of an example of a semiconductor laser with a heat sink.

FIG. 3 is a schematic side view of an example of a semiconductor laser element with a supplementary resonator.

FIG. 4 is a schematic side view of an example of a semiconductor laser element with an etalon.

FIG. 5 is a schematic side view of an example of a semiconductor laser element.

FIG. 6 is a schematic representation of reflection curves of examples of semiconductor laser elements.

### DETAILED DESCRIPTION

Our semiconductor laser may comprise a semiconductor laser element configured to emit electromagnetic radiation when in operation with at least one pumping wavelength or fundamental wavelength. The semiconductor laser element itself may be electrically or optically pumped. It is possible for the semiconductor laser element to be based on a vertically emitting laser, a so-called “Vertical External Cavity Surface Emitting Laser” or VECSEL for short. The semiconductor laser element may comprise a plurality of active layers and take the form of a “multi-quantum well laser element”. Preferably, the semiconductor laser element emits at at least one fundamental wavelength in the red or near infrared spectral range.

The semiconductor component may comprise an end mirror. The end mirror may take the form of a dielectric mirror. The end mirror may be configured to be reflective, with a reflection coefficient greater than or equal to 0.95, both for the fundamental wavelength and for a wavelength produced by conversion of the fundamental wavelength, in particular highly reflective with a reflection coefficient greater than or equal to 0.99.

The semiconductor laser may comprise a deflecting mirror reflective as a function of polarization. “Reflective as a function of polarization” means that the deflecting mirror for example efficiently reflects or assists light with a polarization direction perpendicular to the plane of incidence with regard to the deflecting mirror. In other words, the reflectance of the deflecting mirror is markedly greater for one polarization direction than for another polarization direction. The difference in reflectivity preferably amounts to at least 10%, in particular at least 15%.

Like the end mirror, the deflecting mirror may take the form of a dielectric mirror. With regard to the fundamental wavelength, the deflecting mirror is preferably highly reflective for light of the assisted polarization direction, while, for a wavelength produced from the fundamental wavelength, the deflecting mirror may be highly reflective, partly reflective or transmissive, also independently of the polarization direction.

Light with a polarization plane perpendicular to the plane of incidence of the deflecting mirror is hereinafter described as “perpendicularly polarized,” while light with a polarization direction parallel to the plane of incidence is described as “parallel polarized” light.

The deflecting mirror reflective as a function of polarization may be located between the semiconductor laser element and the end mirror. “Between” means that light emitted by the semiconductor laser element first impinges on the deflecting mirror, is reflected thereby and its direction is changed, and then arrives at the end mirror. The semiconductor laser element, the end mirror and the deflecting mirror form at least part of a resonator of the semiconductor laser.

An end mirror of the resonator of the semiconductor laser may be formed by a dielectric layer sequence on an active layer or layer sequence of the semiconductor laser element, wherein the dielectric layer is located on the side of the active layer remote from the deflecting mirror. By such an end mirror, integrated into the semiconductor laser element, of the resonator of the semiconductor laser, the semiconductor laser may be of very compact construction.

The semiconductor laser may comprise at least one optically nonlinear crystal configured for type II frequency conversion of the fundamental wavelength. This means that the optically nonlinear crystal comprises at least two crystal axes, i.e. the crystal is an optically anisotropic medium. Along one crystal axis the refractive index and thus the speed of light in the crystal is different relative to another crystal axis. In addition, the refractive index along the crystal axes is dependent on the polarization direction and the wavelength of the light.

A direction in the crystal in which perpendicularly and parallel polarized light exhibit the same speed of propagation in the crystal is designated an optical axis of the crystal. Light which exhibits a polarization direction perpendicular to the optical axis is designated as ordinarily polarized light, while light with a polarization direction parallel to the optical axis is designated as extraordinarily polarized. If the crystal is arranged for type II frequency conversion, this means that the for instance linearly perpendicularly polarized light travelling in the resonator may be split in the crystal in identical proportions into an extraordinarily polarized and an ordinarily polarized component. The light in the crystal may thus be regarded as split into two components of different polarization directions, which propagate at different speeds through the crystal. In other words, the light of the fundamental wavelength is composed of an ordinarily and an extraordinarily polarized fraction.

The optically nonlinear crystal may satisfy a λ/2 condition. This means that the crystal is of such a length that the difference in transit time between ordinarily and extraordinarily polarized components of the light in the crystal corresponds to a multiple of half the wavelength of the light. If the propagation speed for example of the ordinarily polarized component is greater than that of the extraordinarily polarized component, the ordinarily polarized component thus overtakes the extraordinarily polarized by n/2 wavelengths, wherein n is a natural number.

The refractive index of the crystal is dependent on the wavelength of the light, both for ordinarily and for extraordinarily polarized light. Use of a type II crystal likewise means that the phase adjustment condition which is required, for example, for frequency doubling is satisfied. In the case of frequency doubling this means that in the direction of propagation of the light the refractive index for the fundamental wavelength is equal to the refractive index of the wavelength produced by conversion. This may be achieved in that light of the fundamental wavelength and light produced by conversion have different polarization directions and/or the crystal has correspondingly oriented crystal axes, such that light of the fundamental wavelength and light produced by conversion propagate at equal speed through the crystal.

Furthermore, the crystal is such that no destruction of the optically nonlinear crystal occurs as a result of the optical outputs occurring during normal operation of the semiconductor laser.

The semiconductor laser may comprise a semiconductor laser element which emits electromagnetic radiation when in operation at at least one fundamental wavelength, an end mirror, a deflecting mirror reflective as a function of polarization, which is located between the semiconductor laser element and the end mirror, and at least one optically nonlinear crystal, which is configured for type II frequency mixing of the fundamental wavelength and which satisfies a λ/2 condition for the fundamental wavelength.

Such a semiconductor laser exhibits narrowband emission of the fundamental wavelength and enables high efficiency during frequency mixing.

The resonator of the semiconductor laser thus comprises a polarization-selective element, namely the deflecting mirror reflective as a function of polarization. In this way, only light of the fundamental wavelength, for example, with perpendicular polarization, is amplified in the resonator. In addition, the optically nonlinear crystal takes the form of a λ/2 element. This means that for certain wavelengths λ the polarization direction of the light travelling through the crystal is maintained. As described, the perpendicularly polarized light is split in the crystal into an ordinarily and an extraordinarily polarized fraction. The λ/2 condition means that the transit time difference corresponds to a multiple of half the light wavelength. This means that this condition is satisfied in the case of a given crystal of a specific length only for specific wavelengths λ, since the λ/2 effect is dependent on the refractive index and thus on the wavelength of the light. Light with unsuitable wavelengths undergoes effective rotation of the polarization direction and is not amplified. In other words, light of unsuitable wavelengths is, for example, no longer perpendicularly polarized after passage through the crystal, but is instead for instance elliptically polarized and undergoes greater recirculation losses at the deflecting mirror reflective as a function of polarization. The combination of deflecting mirror reflective as a function of polarization and optically non-linear crystal, which satisfies a λ/2 condition, thus acts as a wavelength-selective unit or as a filter.

The end mirror and the deflecting mirror may take the form of dielectric mirrors and comprise reflectivity regions which are shifted relative to one another and overlap only in a flank region. Highly reflective dielectric mirrors may exhibit reflectivity regions of a spectral width of around 5 to 10% of a fundamental wavelength, i.e. a dielectric mirror is reflective for a wavelength of 1000 nm in a wavelength range of approx. 950 nm to 1050 nm. At the flanks or edges of this reflectivity region the reflectivity of the mirror drops within a spectral width of a few nanometers from, for example, 99.5% to 10%. The two reflectivity regions of the deflecting mirror and the end mirror are selected such that the reflectivity regions of the two mirrors overlap only in a narrow flank region. This means that, for example, only in a wavelength range of up to 5 nm, in particular only up to 2 nm or only up to 1 nm, both the deflecting mirror and the end mirror display a reflectivity of, for example, more than 98%, preferably of more than 99.9%. Only in this narrow wavelength range does the resonator display high quality. Outside this wavelength range the quality of the resonator is too low, such that the amplification of light outside this wavelength range is impossible or possible only to an extremely limited extent. Such a configuration of the deflecting mirror and the end mirror results in a wavelength-selective resonator, which purposefully suppresses wavelengths which lie outside a desired spectral range.

The semiconductor laser element may comprise a substrate layer in the form of an etalon, wherein the substrate layer is mounted on the side of the active layer of the semiconductor laser element facing the deflecting mirror. The substrate layer may be a growth substrate, on which the active layer or layer sequence is grown. It is also possible for the substrate layer to provide mechanical support for the active layer or layer sequence. For example, the substrate is a growth substrate of gallium arsenide or a carrier substrate of germanium, silicon, silicon carbide, sapphire or diamond. The substrate layer preferably exhibits high thermal conductivity.

An etalon is a wavelength-selective element based on the Fabry-Perot effect. The etalon acts as a type of resonator, which is transmissive only for specific wavelengths. The spectral distance between individual wavelengths transmitted by the etalon is dependent on the thickness of the etalon and of the refractive index thereof. The thickness of the substrate layer forming the etalon is in the range from 20 μm to 1000 μm, in particular in the range from 40 μm to 650 μm. The substrate layer may serve at the same time as a heat sink and heat dissipator for the active layer of the semiconductor element. Such an etalon is compact, efficiently integratable into the semiconductor laser and serves as an additional wavelength-selective element and enables spectral restriction of the radiation of the fundamental wavelength emitted by the semiconductor laser element.

The semiconductor laser, the semiconductor laser element may comprise a supplementary resonator, which preferably takes the form of a semiconductor microresonator. This means that on a side of the active layer of the semiconductor laser element facing the deflecting mirror, a dielectric layer sequence or a layer sequence with a semiconductor material is mounted, which displays a defined reflectivity for the fundamental wavelength. On the side of the active layer remote from the deflecting mirror there is applied a layer which is highly reflective for at least the fundamental wavelength, for example, in the form of a Bragg mirror. This Bragg mirror and the layer sequence form the supplementary resonator for the fundamental wavelength. The supplementary resonator is preferably tuned to the active layers and the Bragg mirror such that an amplitude of an internal standing wave field is particularly high in the active layers and in the part of the resonator not located in the semiconductor laser element. As a function of its length, in accordance with an etalon, the supplementary resonator assists only specific wavelengths and leads to spectral restriction of the fundamental wavelength.

Without additional measures, a semiconductor laser element as a rule comprises a spectral bandwidth in the range from approx. 5 nm up to several tens of nm. As a consequence of the phase adjustment condition, i.e. that both the refractive index for fundamental wavelength and that for a wavelength produced by frequency conversion has to be of equal magnitude in the direction of propagation of the light, an optically nonlinear crystal has only a small spectral width in which the phase adjustment condition is satisfied. This acceptance width may be in the range of a few nm, in particular in the range of approx. 1 to 2 nm. Thus only a small proportion of the pump light emitted by the semiconductor laser element lies in the acceptance range relative to the phase adjustment condition of the crystal. In other words, the efficiency of the frequency conversion is low, as a result of the comparatively large bandwidth of the semiconductor laser element, since only a small part of the radiation emitted by the semiconductor laser element lies in the acceptance range and thus can be converted into another frequency.

Conversion efficiency may be increased by additional measures, by which the fundamental wavelength of the light emitted by the semiconductor laser is spectrally restricted such as, for example, by a deflecting mirror reflective as a function of polarization in combination with a λ/2 element and/or by way of deflecting and end mirrors with mutually displaced reflectivity regions in the resonator of the semiconductor laser and/or by an additional frequency-selective element in the semiconductor laser element. The fundamental wavelength is preferably restricted spectrally to the extent that the spectral width of the fundamental wavelength is less than or equal to the acceptance range of the crystal and thus the entire fundamental wavelength is available for frequency conversion.

The semiconductor laser element may take the form of a semiconductor disc laser. The semiconductor disc laser may be electrically or optically pumped and take the form of a vertically emitting laser. Semiconductor disc lasers are not very thick and allow the semiconductor laser to have a compact structure.

The optically nonlinear crystal may be located between the deflecting mirror and the end mirror. In this way, fractions of the radiation of the fundamental wavelength travelling from the deflecting mirror towards the crystal and reflected back by the end mirror towards the crystal may serve for frequency conversion in the crystal. The light emitted by the semiconductor laser element thus passes through the crystal at least twice, so increasing the efficiency of frequency conversion.

The deflecting mirror may take the form of an outcoupling mirror, i.e. the deflecting mirror is highly reflective for the fundamental wavelength and partially reflective or transmissive for the wavelength produced by conversion. In this case, the end mirror is highly reflective both for the fundamental wavelength and for the wavelength produced by conversion.

The semiconductor laser may comprise at least one focusing element. The light emitted by the semiconductor laser element is then preferably focused either into a point in the crystal or onto the end mirror. If the light of the fundamental wavelength is focused into the crystal, the end mirror preferably takes the form of a focusing mirror. By way of focusing, higher light intensities of the fundamental wavelength may be obtained in the optically nonlinear crystal, whereby frequency conversion efficiency is increased.

The semiconductor laser may comprise any further components in addition to the semiconductor laser element, the end mirror, the deflecting mirror, the crystal and the focusing element. Components are understood in particular to be those components which have an optical action. Such components are for example polarizers, retardation plates or diaphragms. By minimizing the number of components, the semiconductor laser may be of compact design, so reducing manufacturing costs therefor.

The crystal may be configured for frequency doubling of the fundamental wavelength. Frequency doubling is an efficient type of frequency conversion and makes it possible to convert near infrared light into the visible spectral range and to obtain an inexpensive light source of high efficiency.

The fundamental wavelength may be in the near infrared spectral range between 780 nm and 1550 nm. The semiconductor laser element preferably emits a fundamental wavelength in the range between 900 nm and 1100 nm. Fundamental wavelengths in this spectral range may be efficiently produced by high-efficiency semiconductor laser elements and supply for example doubled light in the blue, green or red spectral range.

The optical nonlinear crystal may have a geometric length of between 1 and 10 mm inclusive, preferably between 2 mm and 6 mm, in particular between 3 mm and 5 mm. Geometric length is understood to mean that dimension of the crystal which lies in the beam direction, i.e., for example, parallel to the light of the fundamental wavelength.

The angle between a resonator arm formed by semiconductor laser element and deflecting mirror and a resonator arm formed by end mirror and deflecting mirror may be in a range from 60° to 120° inclusive. The angle between the two resonator arms preferably amounts to around 90°. Deflecting mirrors exhibiting high polarization selectivity are inexpensive to produce for this angular range. Adjustment of the semiconductor laser is in particular simplified for an angle of 90°.

The spectral width of the fundamental wavelength may amount at most to 3 nm, preferably at most to 1 nm, in particular at most to 0.3 nm. The spectral width is defined as the full width of the spectrum at half maximum, also known as FWHM. Such small spectral widths of the fundamental wavelength are of the order of magnitude of the acceptance range of the optically nonlinear crystal and allow efficient frequency conversion.

The total geometric length may amount to at most 25 mm, preferably at most 15 mm, in particular at most 10 mm. The total length is defined as geometric distance corresponding to the resonator length of the semiconductor laser. This distance corresponds to the light path from the end mirror via the deflecting mirror to the highly reflective layer of the semiconductor laser element located on the side of the active layer of the semiconductor laser element remote from the deflecting mirror. Such total lengths of the semiconductor laser or of the resonator thereof allow a compact structure of the semiconductor laser and a high degree of stability and robustness with regard to external environmental influences such as for example temperature fluctuations.

The semiconductor laser may comprise a heat sink on which is mounted the semiconductor laser element. Furthermore, the semiconductor laser may comprise a monitor diode, by which the power and/or wavelength emitted by the semiconductor laser element may be measured and/or adjusted. As a further option, the semiconductor laser may comprise a temperature control unit, by which the temperature of the semiconductor laser element and/or the optically nonlinear crystal may be adjusted. Through the cumulative or alternative use of such components, the emission characteristics of the frequency-mixed light of the semiconductor laser may be adjusted and/or stabilized.

A semiconductor laser described herein will be explained in greater detail below with reference to the drawings and with the aid of examples. Elements which are the same in the individual figures are indicated with the same reference numerals. The relationships between the elements are not shown to scale, however, but rather individual elements may be shown exaggeratedly large to assist in understanding.

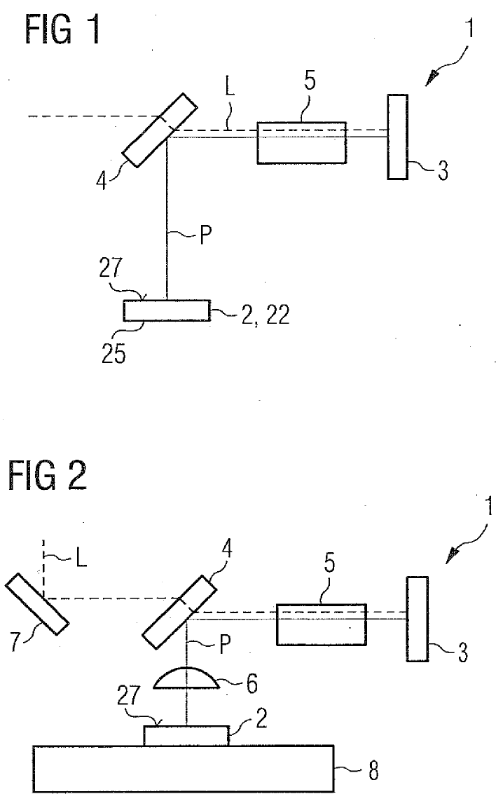

Turning now to the drawings, FIG. 1 shows an example of a semiconductor laser 1. A semiconductor laser element 2 emits light of a fundamental wavelength P from a light outlet face 27 towards a deflecting mirror 4. The pump light P is deflected by the deflecting mirror 4 towards an end mirror 3. Between the deflecting mirror 4 and the end mirror 3 there is located an optically nonlinear crystal 5, which is configured for type II frequency conversion. The deflecting mirror 4 has a reflectivity of at least 99% for light of the fundamental wavelength P which is polarized perpendicularly to the plane of incidence, and a reflectivity of at most 80% for parallel polarized light.

Pump light P coming from the deflecting mirror 4, symbolized by a continuous line, is converted by the crystal 5 at least in part by frequency conversion, for example frequency doubling, into light L of a different wavelength symbolized by a dashed line. This light L travels together with the fraction of unconverted pump light P towards the end mirror 3. Both the converted light L and the remaining part of the fundamental radiation P are reflected by the end mirror 3 back towards crystal 5 and deflecting mirror 4. The fundamental light P still present passes through the crystal 5 a second time, so increasing the efficiency of the frequency conversion since fundamental radiation P is again converted into light L. The light L is transmitted by the deflecting mirror 4, which is also configured as an outcoupling mirror. Light of the fundamental wavelength P is reflected by the deflecting mirror 4 back towards the semiconductor laser element 2.

The semiconductor laser element 2 comprises an active layer or an active layer sequence 22, which emits light P of the fundamental wavelength when in operation. On a side of the active layer 22 remote from the deflecting mirror 4 there is mounted a layer which is highly reflective for the fundamental wavelength P, for example in the form of a Bragg mirror 25, or DBR for short. Together with the end mirror 3, this highly reflective layer forms the end mirrors of the resonator of the semiconductor laser 1. A geometric length of the resonator from the highly reflective Bragg mirror 25 to the end mirror 3 amounts to around 10 mm.

In the example according to FIG. 2, the semiconductor laser 1 additionally comprises a focusing element 6 and a heat sink 8. The focusing element 6 is configured as a lens and focuses the radiation P onto the end mirror 3. Since the optically nonlinear crystal 5 is located in the vicinity of the end mirror 3, the radiation P is virtually focused in the crystal 5. In this way relatively high optical power densities of the radiation of the fundamental wavelength P are achieved in the crystal 5, such that frequency conversion also proceeds more efficiently.

The semiconductor laser element 2, which may take the form of a semiconductor disc laser, is mounted on the heat sink 8. Heat arising during operation of the semiconductor laser element 2 may be dissipated efficiently therefrom by way of the heat sink 8.

The converted light L arriving from the semiconductor laser 1 via the deflecting mirror 4 configured as an outcoupling mirror then impinges on a mirror 7 via which the light L is deflected into a desired spatial region. The mirror 7 may take the form of a focusing optical element.

The crystal 5 has a geometric length in the beam direction of around 4 mm. Possible crystal materials are for instance KTP, LBO or BBO, as a function of the frequency range to be achieved and of the fundamental wavelength. At a fundamental wavelength of the radiation P of around 1000 nm, the spectral distance between wavelengths, which do not undergo any change in polarization direction by way of the crystal 5 due to a λ/2 effect, amounts to around 1 nm to 2 nm. By the deflecting mirror 4, which reflects perpendicularly polarized light of the pump radiation P but is markedly less reflective for parallel polarized light of the pump radiation P, only those wavelengths which have the same polarization direction after passing through the crystal 5 as before passing through the crystal 5 are assisted by the resonator of the semiconductor laser 1. This results in effective restriction of the wavelength of the pump radiation P to those wavelengths for which the crystal 5 effectively does not rotate the polarization direction.

Alternatively or in addition, the mirrors in the form of dielectric mirrors, the end mirror 3 and the deflecting mirror 4, may exhibit reflectivity regions which overlap only in a narrow spectral range. In this way, a further wavelength selectivity of the semiconductor laser 1 relative to the fundamental wavelength of the radiation P may be achieved. It is possible for the radiation P emitted by the semiconductor laser element 2 thus to comprise a spectral width which is smaller than or comparable to an acceptance width of the crystal 5 which is relevant to frequency conversion as a result of a phase adjustment condition.

Furthermore, the semiconductor laser element 2 may be such that the spectral width of the radiation of the fundamental wavelength P, which is emitted by the semiconductor laser element 2, has already been restricted at least in part by the semiconductor laser element 2 itself.

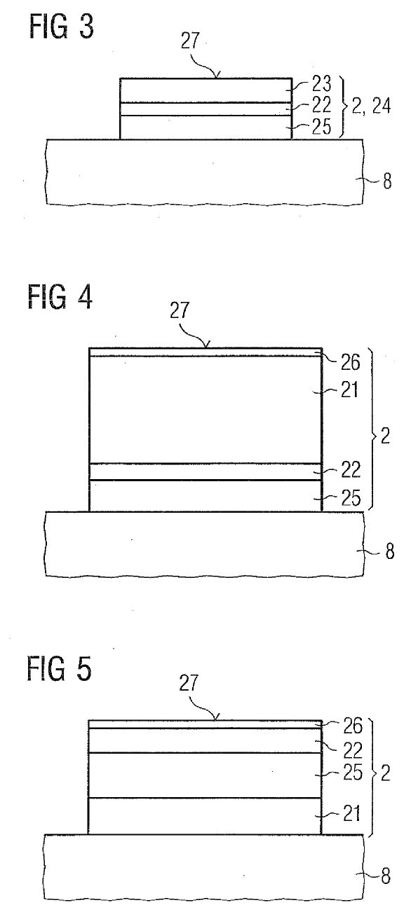

FIG. 3 shows a semiconductor laser element 2 of a semiconductor laser 1 which has been mounted on a heat sink 8. From the main side of the heat sink 8 facing the light outlet face 27, the semiconductor laser element 2 first comprises a highly reflective layer sequence configured as a Bragg mirror 25, followed by the active layer or layer sequence 22, on which a further dielectric or semiconductor layer sequence 23 is mounted, which also forms the light outlet face 27. Components which are not of primary importance for optical functioning such as, for instance, power supply or a pump light source for optical pumping of the semiconductor laser element 2, are not shown in the drawings for the sake of clarity.

The layer sequence 23 is configured such that it is partially reflective for the radiation produced by the active layer 22. The layer sequence 23 together with the Bragg mirror 25 thus form a supplementary resonator 24, in which is located the active layer 22. The optical length of the supplementary resonator 24 is of the order of magnitude of the fundamental wavelength of the radiation P. The supplementary resonator 24 thus has a length which is shorter by several orders of magnitude than the entire resonator of the semiconductor laser 1, whose length is in the millimeter range. The supplementary resonator 24 constitutes a Fabry-Perot element, which only assists those wavelengths which correspond to an integral multiple of half the fundamental wavelength. The active layer 22 has a spectral amplification range, without additional measures, which comprises a bandwidth of around 10 nm. By the Fabry-Perot effect of the supplementary resonator 24, specific fundamental wavelengths are selected, as an additional or alternative measure to the wavelength-restricting measures described for example in the example according to FIG. 2.

Semiconductor laser elements without spectral restriction of the amplification bandwidth comprise a Bragg mirror 25, on which an active layer 22 is applied. The light outlet face 27 is formed of a material of the active layer or of the active layer stack 22. As a result of the typically large refractive index difference between air and this material, a high proportion of the light produced in the active layer 22 of the fundamental wavelength P is reflected at the light outlet face 27 back into the semiconductor laser element 2. In this way, a high radiant intensity develops in the semiconductor laser element 2, but the radiant intensity in the resonator of the semiconductor laser 1 is only comparatively low outside the semiconductor laser element 2. In this way, the efficiency of the frequency conversion is reduced.

Due to the high reflectivity of the boundary layer, there is likewise stronger coupling between the resonator of the semiconductor element 2, formed by Bragg mirror 25 and light outlet face 27, the length of which resonator lies in the range of the fundamental wavelength of the radiation P, and the remainder of the resonator of the semiconductor laser 1, whose length is in the millimeter range. As a result of this strong coupling between these two resonator parts, major optical power fluctuations may arise when the semiconductor laser 1 is in operation.

As a result of the dielectric layer sequence 23, as shown in the example according to FIG. 3, the reflectivity of the supplementary resonator may be purposefully adjusted over a wide range of values. The reflectivity for light of the pump radiation P of the dielectric layer sequence 23 is preferably in the range from 20% to 60%, in particular around 30%. Furthermore, the precise length of the supplementary resonator 24 and thus the fundamental wavelength assisted thereby of the radiation P may be adjusted by the layer sequence 23.

With a non-spectrally restricted semiconductor laser element 2 without layer sequence 23, the quality of the resonator-like structure formed by the Bragg mirror 25 and light outlet face 27 is greatly influenced by the manufacturing tolerances of the active layer 22, the coefficients of thermal expansion, the electrical and thermal conductivity of the layer 22 and the dependency thereof of the refractive index on temperature. This requires a high level of manufacturing effort, since high manufacturing precision is necessary to adjust all the parameters accordingly. Using a layer sequence 23 or indeed a substrate layer 21 according to FIG. 4 may increase manufacturing tolerances and makes the semiconductor laser more insensitive to external disruptive factors when in operation.

In the example according to FIG. 4, the semiconductor laser element 2 comprises a substrate layer 21 of for instance gallium arsenide, which is applied to the side of the active layer 22 facing the light outlet face 27. The substrate layer 21 is preferably transparent for the wavelength of the pump radiation P. The thickness of the substrate layer 21 may be adjusted for example by grinding, polishing and/or etching. By the jump in the refractive index between substrate layer 21 and active layer 22, on the one hand, and between substrate layer 21 and the air surrounding the semiconductor laser element 2, on the other hand, the substrate layer 21 in turn forms a wavelength-selective etalon based on the Fabry-Perot effect. The wavelengths assisted by the etalon may be purposefully adjusted by the thickness of the substrate layer 21. Since the refractive index of the substrate layer 21 may lie between that of air and that of the active layer 22, it is also possible for the reflectivity of the light outlet face 27 in comparison with a semiconductor laser element 2 without such a substrate layer 21 to be comparatively low, so ensuring a high intensity of the light of the fundamental wavelength P in resonator regions outside the semiconductor laser element 2.

The substrate layer 21 may also serve as a growth substrate for the active layer 22. Furthermore, heat resulting from operation of the semiconductor element 2 may likewise be dissipated via the substrate layer 21. On the side of the substrate layer 21 remote from the heat sink 8, a coating 26 may optionally be applied, by which the reflectivity of the light outlet face 27 may be additionally adjusted. The coating 26 may optionally also be highly reflective for the converted light L produced from the light of the fundamental wavelength P.

In the example of the semiconductor laser element 2 according to FIG. 5, the substrate layer 21 is mounted on the heat sink 8. The Bragg mirror 25 is located between the substrate layer 21 and the active layer 22, which is applied on a side of the Bragg mirror 25 remote from the substrate layer 21. The light outlet face 27 is optionally formed of the coating 26.

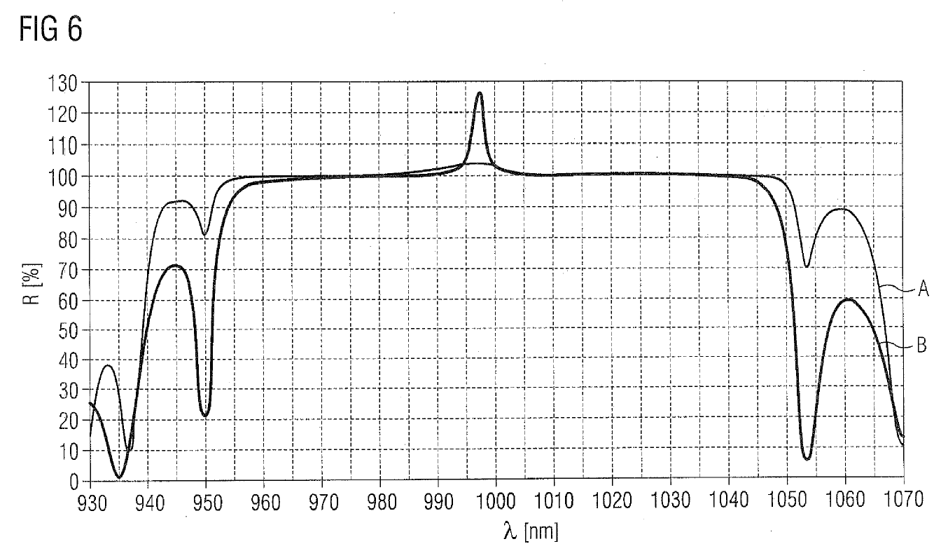

FIG. 6 shows a reflectivity R of a semiconductor laser element 2 with the layer sequence 23 according to FIG. 3, see curve B in FIG. 6, and the reflectivity R of a semiconductor laser element 2, for example, according to FIG. 5, without such a layer sequence 23, see curve A in FIG. 6. Reflectivity R is plotted relative to wavelength λ. A reflectivity R of more than 100% corresponds to amplification by the semiconductor laser element 2. The amplification exhibits a maximum at approx. 998 nm. In the spectral range between around 960 nm and 1040 nm, reflectivity R amounts to just 100%, substantially determined by the quality of the Bragg mirror 25.

Without the layer sequence 23 a spectral half-value width, FWHM, of the amplification of the semiconductor laser element amounts to around 10 nm, see curve A, and is significantly greater than the acceptance range of a nonlinear crystal 5. The spectral width of the amplification is reduced to approx. 2.5 nm by the layer sequence 23 in curve B. In addition, amplification is markedly increased with layer sequence 23 and is around 126%, in comparison with around 104% without layer sequence 23.

The apparatus described herein is not restricted by the description given with reference to the examples. Rather, this disclosure encompasses any novel feature and any combination of features, including in particular any combination of features in the appended claims, even if this feature or this combination is not itself explicitly indicated in the claims or examples.

1.-15. (canceled)

16. A semiconductor laser comprising:
a semiconductor laser element that emits electromagnetic radiation with at least one fundamental wavelength when in operation,
an end mirror,
a deflecting mirror reflective as a function of polarization located between the semiconductor laser element and the end mirror, and
at least one optically nonlinear crystal configured for type II frequency conversion of the fundamental wavelength and which satisfies a λ/2 condition for the fundamental wavelength.

17. The semiconductor laser according to claim 16, wherein the end mirror and the deflecting mirror take the form of dielectric mirrors and comprise spectral reflectivity regions displaced relative to one another and overlap only in a spectral flank region.

18. The semiconductor laser according to claim 16, wherein the semiconductor laser element comprises a substrate layer configured as an etalon and mounted on a side of an active layer of the semiconductor laser element facing the deflecting mirror.

19. The semiconductor laser according to claim 16, wherein the semiconductor laser element comprises a supplementary resonator with a dielectric layer sequence mounted on the side of the active layer of the semiconductor laser element facing the deflecting mirror.

20. The semiconductor laser according to claim 16, wherein the semiconductor laser element is a semiconductor disc laser.

21. The semiconductor laser according to claim 16, wherein the crystal is located between the deflecting mirror and the end mirror.

22. The semiconductor laser according to claim 16, wherein the deflecting mirror is an outcoupling mirror.

23. The semiconductor laser according to claim 16, further comprising at least one focusing element wherein light of the fundamental wavelength is focused onto a point in the crystal or onto the end mirror.

24. The semiconductor laser according to claim 16, which is free of further components in addition to the semiconductor laser element, the end mirror, the deflecting mirror, the crystal and which optionally comprise a focusing element.

25. The semiconductor laser according to claim 16, wherein the crystal is configured for frequency doubling of the fundamental wavelength.

26. The semiconductor laser according to claim 16, wherein the fundamental wavelength is between 820 nm and 1350 nm.

27. The semiconductor laser according to claim 16, wherein the crystal has a geometric length of 1 mm to 10 mm.

28. The semiconductor laser according to claim 16, wherein the angle between a resonator arm formed by the semiconductor laser element and the deflecting mirror and a resonator arm formed by the end mirror and the deflecting mirror is 60° to 120° inclusive.

29. The semiconductor laser according to claim 16, wherein spectral width of the fundamental wavelength is less than or equal to 0.3 nm.

30. The semiconductor laser according to claim 16, having total geometric length less than or equal to 25 mm.
